(19) United States
(12) Patent Application Publication
(10) Pub. No.: US 2024/0157834 A1
(43) Pub. Date: May 16, 2024

(54) METHOD FOR PROVIDING AN ADDITIONAL CAPACITY OF AN ELECTROCHEMICAL ENERGY STORE OF AN ELECTRICALLY DRIVABLE VEHICLE

(71) Applicant: Robert Bosch GmbH, Stuttgart (DE)

(72) Inventors: Emmanuel Rolin, Leonberg (DE); Florent Collenot, Schorndorf-Weiler (DE)

(21) Appl. No.: 18/508,991

(22) Filed: Nov. 14, 2023

(30) Foreign Application Priority Data
Nov. 15, 2022 (DE) 10 2022 212 138.4

(51) Int. Cl. B60L 53/62; B60L 53/51; B60L 58/13; B60L 58/22

(52) U.S. Cl. CPC B60L 53/62; B60L 53/51; B60L 58/13; B60L 58/22; B60L 2260/52

(57) ABSTRACT

A method for providing an additional capacity of an electrochemical energy store of an electrically drivable vehicle.

### BACKGROUND

The invention is based on a method for providing an additional capacity of an electrochemical energy store of an electrically drivable vehicle, an apparatus for operating an electrochemical energy store, a computer program, and a use of a method for providing an additional capacity of an electrochemical energy store of an electrically drivable vehicle.

Electrically powered vehicles have a control unit that manages the battery data, for example calculating the available range.

The network of charging stations is not yet fully developed, so there is a high risk of immobilization due to low battery capacity. Also, available charging stations do not always work as expected or the charging current or charging power is limited by the infrastructure. On-site “filling” of the vehicle by a towing service, comparable to a fuel tank of a combustion engine, is not possible. Towing is therefore usually necessary, which costs time and money.

The document US 2020 254 898 A1 discloses a system and a method for improvements in the areas of electric vehicle range, availability of charging stations, and required charging time for electric vehicles.

### SUMMARY

In contrast, the method according to the disclosure has the advantage that the method comprises the following steps:
reserving the additional capacity of a total capacity of the electrochemical energy store which is not used for regular driving operation of the electrically powered vehicle;
determining a range predicted with the additional capacity based on a route profile between a current position of the electrically drivable vehicle and a predetermined destination, weather conditions, traffic situation, vehicle type of the electrically drivable vehicle and/or driver profile;
outputting the determined predicted range if a maximum achievable range of the electrically drivable vehicle falls below a specified minimum achievable range of the electrically drivable vehicle;
detection of a release variable, which represents a release of the additional capacity by a driver of the electrically drivable vehicle and/or an operator of the electrically drivable vehicle;
comparing the recorded release variable with a target release variable; and
release of the additional capacity of the electrochemical energy store depending on the comparison.

The method according to the invention for providing an additional capacity of an electrochemical energy store further comprises the following step:
b.2) determining a further predicted range with reduced available power, in particular due to a reduced maximum speed, acceleration, and/or reduced electrical consumption for all non-safety-relevant consumers of the electrically drivable vehicle, based on a route profile between a current position of the electrically drivable vehicle and a predefined destination, weather conditions, traffic situation, vehicle type of the electrically drivable vehicle, and/or driver profile.

The method according to the invention for providing an additional capacity of an electrochemical energy store further comprises the following step:
b.3) determining geographical coordinates of locations relevant to the driver of the vehicle, in particular parking lots, overnight accommodation, and/or repair shops, if the ranges predicted with the additional capacity and/or the ranges predicted with the additional capacity at reduced available power are less than a minimum necessary range to reach a public charging facility.

A predetermined capacity, for example 10 percent, of a maximum available capacity of the electrochemical energy store or a comparable minimum range of 50 km is reserved as additional capacity by a battery management system of the electrochemical energy store.

To reserve the additional capacity, a predetermined number of energy storage cells of the electrochemical energy store can be electrically switched off by means of at least one switch, or to release the additional capacity, a predetermined number of energy storage cells of the electrochemical energy store can be electrically switched on by means of the at least one switch.

To provide the additional capacity, the specified number of energy storage cells are charged, in particular via regeneration processes and/or photovoltaic cells of the electrically powered vehicle.

An apparatus according to the invention for operating an electrochemical energy store comprises at least one sensor for detecting an electrical voltage, current, and/or temperature of the electrochemical energy store and at least one means, in particular an electronic battery management control unit, which are set up to carry out the steps of the method according to the invention for providing an additional capacity of an electrochemical energy store.

According to an advantageous embodiment of the invention, a computer program is provided comprising instructions which cause the apparatus for operating an electrochemical energy store to carry out the method steps according to the invention.

A machine-readable storage medium, on which the computer program is stored, is provided as well.

A method according to the invention for limiting an intermediate circuit voltage of an electrically drivable vehicle is advantageously used for electric vehicles, fuel cell vehicles, hybrid vehicles, plug-in hybrid vehicles, aircraft, pedelecs, or e-bikes.

### BRIEF DESCRIPTION OF THE DRAWINGS

Exemplary embodiments of the invention are shown in the drawing and explained in more detail in the following description.

Shown are:

FIG. 1 a schematic representation of a flow chart of an embodiment of a method according to the invention for providing an additional capacity of an electrochemical energy store; and

FIG. 2 a schematic representation of an embodiment of an apparatus according to the invention for operating an electrochemical energy store.

### DETAILED DESCRIPTION

Identical reference signs designate identical apparatus components in all of the figures.

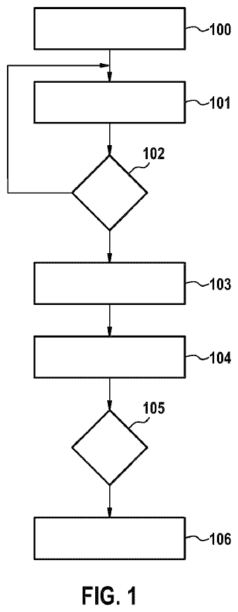

FIG. 1 shows a schematic representation of a flow chart of an embodiment of a method according to the invention for providing an additional capacity of an electrochemical energy store.

In step 100, the additional capacity of a total capacity of the electrochemical energy store, which is not used for regular driving operation of the electrically drivable vehicle, is reserved. In the embodiment shown, essentially 10 percent of the total capacity of the electrochemical energy store is reserved by a battery management system.

In step 101, a range predicted with the additional capacity is determined based on a route profile between a current position of the electrically drivable vehicle and a predetermined destination, weather conditions, traffic conditions, vehicle type of the electrically drivable vehicle, and/or driver profile. This information can be determined, for example, by means of a navigation system of the vehicle or by means of a navigation system separate from the vehicle and/or a data source of a control unit spatially separate from the vehicle, wired and/or wireless.

In step 102, the determined predicted range is compared with a predetermined minimum range to be achieved by the electrically drivable vehicle. If the predicted range falls below the specified minimum range to be achieved, the method is continued in step 103. Otherwise, the method is continued in step 101.

In step 103, the determined predicted range is output visually, acoustically, and/or haptically, for example to a driver of the electrically drivable vehicle.

In step 104, a release variable representing a release of the additional capacity by a driver of the electrically drivable vehicle and/or an operator of the electrically drivable vehicle is detected.

In step 105, the detected release variable is compared with a target release variable. If the detected release variable essentially corresponds to the target release variable, the method is continued in step 106.

In step 106, the additional capacity of the electrochemical energy store is released.

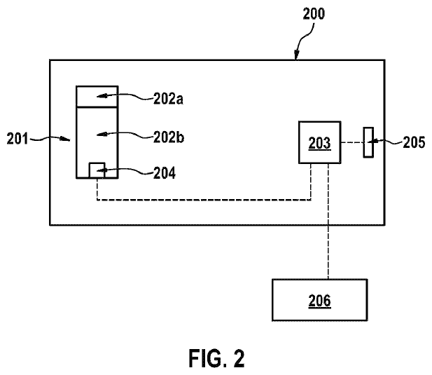

FIG. 2 shows a schematic representation of an embodiment of an apparatus 200 according to the invention for operating an electrochemical energy store 201. The electrochemical energy store comprises at least one electrochemical energy store 201. The electrochemical energy store comprises a plurality of electrochemical energy storage cells, wherein a total capacity essentially comprises all electrochemical energy storage cells.

A battery management system 203 detects the electrical voltage, current, and/or temperature of the electrochemical energy store 201 by means of at least one sensor 204, wired and/or wireless. The battery management system 203 can reserve a portion of the total capacity as additional capacity 202a, whereby only a portion of the total capacity is available as available capacity 202b to electrical consumers, for example a traction drive, of the electrically drivable vehicle.

By means of a display 205, the battery management system 203 can visually output a predicted range, in particular of the additional capacity 202a. The range available due to the additional capacity can be used advantageously for an emergency. This can prevent the electrically powered vehicle from being towed away.

By means of a wireless connection, the battery management system 203 detects a release variable of a control unit 206 spatially remote from the apparatus 200 according to the invention.

1. A method of providing additional capacity of an electrochemical energy store (201) of an electrically drivable vehicle, comprising the following steps:
a) (100) reserving the additional capacity (202a) of a total capacity of the electrochemical energy store (201), which is not used for regular driving operation of the electrically drivable vehicle;
b) (101) determining a range predicted with the additional capacity (202a) based on a route profile between a current position of the electrically drivable vehicle and a predetermined destination, weather conditions, traffic conditions, vehicle type of the electrically drivable vehicle, and/or driver profile;
c) (103) outputting the determined predicted range if the predicted range of the electrically drivable vehicle falls below a predetermined minimum range to be achieved by the electrically drivable vehicle;
d) (104) detecting a release variable representing a release of the additional capacity by a driver of the electrically drivable vehicle and/or an operator of the electrically drivable vehicle;
e) (105) comparing the detected release variable with a target release variable; and
f) (106) releasing the additional capacity of the electrochemical energy store (201) depending on the comparison.

2. The method for providing an additional capacity (202a) of an electrochemical energy store (201) according to claim 1, further comprising the following step:
b.2) determining a further predicted range with reduced available power due to a reduced maximum speed, acceleration, and/or reduced electrical consumption for all non-safety-relevant consumers of the electrically drivable vehicle, based on a route profile between a current position of the electrically drivable vehicle and a predefined destination, weather conditions, traffic situation, vehicle type of the electrically drivable vehicle, and/or driver profile.

3. The method for providing an additional capacity (202a) of an electrochemical energy store (201) according to claim 1, further comprising the following step:
b.3) determining geographical coordinates of locations relevant to the driver of the vehicle including parking lots, overnight accommodation, and/or repair shops, when the ranges predicted with the additional capacity and/or the ranges predicted with the additional capacity at reduced available power are less than a minimum necessary range to reach a public charging facility.

4. The method for providing an additional capacity (202a) of an electrochemical energy store (201) according to claim 1, wherein a predetermined capacity of a maximum available capacity of the electrochemical energy store (201) is reserved as additional capacity (202a) by a battery management system (203) of the electrochemical energy store (201).

5. The method for providing an additional capacity (202a) of an electrochemical energy store (201) according to claim 1, wherein, for reserving the additional capacity (202a), a predetermined number of energy storage cells of the electrochemical energy store (201) can be electrically switched off by means of at least one switch or can be electrically switched on by means of the at least one switch for releasing the additional capacity (202a).

6. The method for providing an additional capacity (202a) of an electrochemical energy store (201) according to claim 1, wherein for providing the additional capacity (202a) the predetermined number of energy storage cells are charged via regenerating processes and/or photovoltaic cells of the electrically drivable vehicle.

7. An apparatus for operating an electrochemical energy store (201), comprising at least one sensor (204) for detecting an electrical voltage, current, and/or temperature of the electrochemical energy store (201) and an electronic battery management controller, which are set up to carry out the steps of the method according to claim 1.

8. A computer program comprising instructions that operate to perform the method steps of claim 1.

9. A machine-readable storage medium on which the computer program according to claim 8 is stored.

10. The method for providing an additional capacity of an electrochemical energy store (201) of an electrically drivable vehicle according to claim 1, for use in storing electrical energy for electric vehicles, fuel cell vehicles, hybrid vehicles, plug-in hybrid vehicles, aircraft, pedelecs, or e-bikes.
